(19) United States
(12) Patent Application Publication
(10) Pub. No.: US 2003/0185289 A1
(43) Pub. Date: Oct. 2, 2003

(54) Cordless modem for portable computers

(75) Inventors: Antonio Colmenarez, Peekskill, NY (US); Srinivas Gutta, Buchanan, NY (US); Miroslav Trajkovic, Ossining, NY (US)

Correspondence Address: PHILIPS ELECTRONICS NORTH AMERICAN CORP, 580 WHITE PLAINS RD, TARRYTOWN, NY, 10591, US

(73) Assignee: KONINKLIJKE PHILIPS ELECTRONICS N.V.

(21) Appl. No.: 10/020,055

(22) Filed: Dec. 7, 2001

(51) Int. Cl. H04B 1/38

(52) U.S. Cl. 375/222

(57) ABSTRACT

A system and method for cordless communication between a modem of a computer and a communication line includes a base station and at least a remote unit. A booster station can be optionally included to increase reception to the remote unit. The base station will be adapted for connection with the communication line, and will transmit via RF to the remote unit. The base station may test the communications over a plurality of available channels and select the channel with the strongest reception. The booster station may also communicate via RF with the remote unit, and may optionally plug into an electrical outlet, and communicate with the base station over common wiring when the base station is similarly attached to another outlet of the common wiring. The system may compare reception between the base station and the remote unit with the booster station and the remote unit, and may communicate with the booster station only over the electrical wires to reduce RF transmissions.

### BACKGROUND OF THE INVENTION

1. Field of the Invention

The present invention relates to communication devices. More particularly, the present invention relates to modems for personal computers.

2. Description of the Related Art

Conventional personal computers have modems for communicating over a carrier, such as a telephone, DSL line, etc. For stationary computers, it is common to have a dedicated phone jack which is used by the computer for access, for example, to the Internet. The jack may also be used for communication with a Local Area Network, which can then be the portal through which the Internet is accessed.

However, portable person computers are becoming increasingly common. Users of portable personal computers can often perform work while away from a station, such as a desk. Even though a user may have the capability to take the personal computer anywhere in the home or office, if Internet access is desired, a standard wired phone jack or LAN/WAN connection is necessary. These standard phone jacks are often limited in distance, unsightly, and often pose a hazard for other people that might trip over them, and/or possibly drag the computer off its resting place (such as a table) and cause permanent damage to the computer. In addition, small hand held computer units will be impractical and unsightly if a physical cord is attached to same. Thus, there is a need in the art for a cordless modem for computers, particularly portable computers. Despite the existence of cordless phones for many years, the need for cordless modems has not been met.

### SUMMARY OF THE INVENTION The present invention provides a system and a method providing a cordless modem for a computer.

A system according to the present invention may comprise:

a base station comprising means for connection with a communication line;

a remote unit for connection with an interface of a modem;

said base station including means for wireless communication with said remote unit;

said remote unit comprising means for wireless communication with at least said base station;

said base station including means for testing and selecting a frequency providing a strongest reception from a plurality of available channels for wireless communication between said base station and said remote unit.

According to an aspect of the present invention, the means for testing includes means for comparing levels of test patterns communicated between said base station and said remote unit.

Another aspect of the present invention may comprise at least one booster station being in wireless communication with the base station and the remote unit, the booster station including receiving means for receiving information transmitted from the base station and the remote unit and transmitting means for transmitting information to the base station and the remote unit.

Yet another aspect of the present invention is that the base station may include means for connection with a first electrical outlet, and there is at least one booster station being in wireless communication with the remote unit. The booster station may include means for connection with a second electrical outlet, and the base station and the booster station includes means for communication over a common electrical wiring system between the first and second electrical outlets.

Still another aspect of the present invention is that the booster station includes means for testing and selecting a frequency providing a strongest reception from a plurality of available channels for wireless communication between the booster station and the remote unit, and when reception between the booster station and the remote unit is stronger than reception between the base station and the remote unit, the base station communicates with the booster station only via the common electrical wiring system.

In still another aspect of the present invention, the base station periodically tests wireless communication with the remote unit and when reception between the base station and the remote unit is stronger than reception between the booster station and the remote unit, the base station stops communicating with the booster station via the common electrical wiring system and wirelessly communicates directly with the remote unit.

A method according to the present invention may comprise the steps of:

(a) providing a base station adapted for connection with a communication line;

(b) providing a remote unit adapted for connection with an interface of a modem;

(c) providing wireless communication between said base station and said remote unit;

(d) testing wireless transmissions to and from said base station and said remote unit;

(e) comparing a received signal strength from the remote unit with the wireless transmissions transmitted by the base station in step (d); and

(f) repeating steps (d) and (e) for a plurality of channels having different frequencies, and selecting a channel having a strongest signal strength from among the plurality of channels.

The method may include (g) providing at least one booster station in wireless communication with said base station and said remote unit, said booster station receiving and re-transmitting communications between said base station and said remote unit.

### BRIEF DESCRIPTION OF THE DRAWINGS

FIG. 1A illustrates an overview an embodiment of a system according to the present invention.

FIG. 1B provides detail regarding the base station shown in FIG. 1A.

FIG. 2 illustrates an alternative embodiment of the present invention.

FIG. 3 is a flowchart providing an overview of a method according to the present invention.

FIG. 4 provides optional steps for the flowchart shown in FIG. 3.

FIG. 5 provides additional optional steps for the flowchart shown in FIG. 3.

### DETAILED DESCRIPTION OF THE INVENTION

By way of illustration and not limitation, the following figures and their associated description provide an explanation of certain aspects of a system and method according to the present invention. It is understood by persons of ordinary skill in the art that there are variations to the illustrated system and method which are within the spirit of the invention and the scope of the appended claims, and as such the invention is not limited to the illustrations, which have been provided for explanatory purposes.

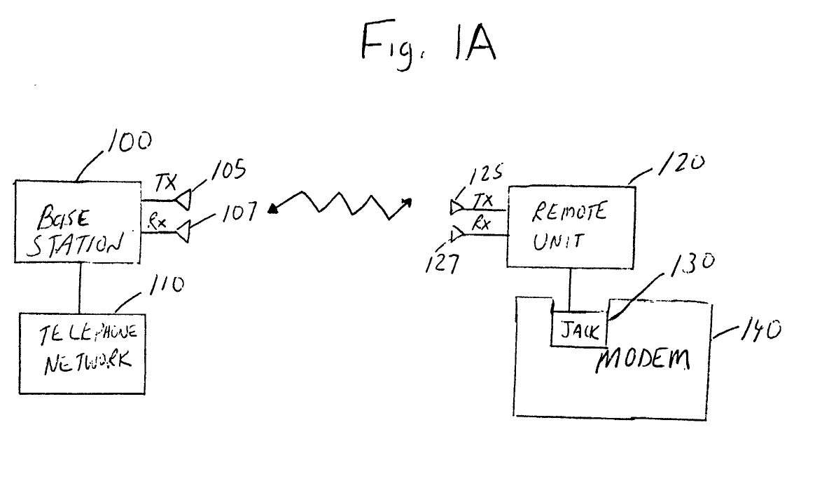

FIG. 1A illustrates an overview of a system for a cordless modem according to the present invention. A base station 100 includes transmitter 105 and receiver 107. The type of transmission can be the same format as used by conventional cordless telephone. The base station 100 is connected to a communication line, which can be a standard telephone line, or could be connected to a high speed link, such as a DSL connection.

Remote unit 120 includes a transmitter 125 and a receiver 127 for communicating with the base station 110. This remote unit also is adapted for attachment to the jack of a standard modem used in a computer. The remote unit may have a modular plug that fits directly into the receptacle 130 of a modem 140, or a modular jack may be provided to connect the modem to the remote unit. However, in this embodiment, it should be understood that the cordless system does not include the modem or receptacle, that being standard equipment on modems installed in most computers.

It is understood by persons of ordinary skill in art that it is within the spirit and scope of the invention that a modem in communication with the presently claimed remote unit may be capable of high speed transfer, and/or could be installed as after market equipment. So long as the wireless transmission rate of the system is compatible the high speed transfer rate of the modem, the speeds to do not have to be an exact match, but should be sufficiently close so as to not result in an overrun of transmitted data, or a timing out of the wireless communication sequence. The inclusion of a storage buffer may be advantageous under such conditions.

It is envisioned that new computers may be built so that the remote unit is embedded in the case of the computer, wherein the antenna could be extendable from the case to improve reception. The manufacturer of the computer would supply the base station with the purchase of the computer, or sell it as an add-on feature.

Alternatively, the antenna may comprise a strip line antenna arranged along an outer edge of the case, preferable positioned so that, the antenna is facing upward when the portable computer is opened.

FIG. 1B illustrates detail of the base station 100. The base station may include means for testing 102 the transmission between the remote and the base. This testing could include the generation of a test pattern that is periodically transmitted while the system is in use and there is a comparison of the transmitted and received pattern by a comparator 103, the output of which is provided back to the means for testing 102 as feedback. The means for testing 102 can also be part of or communicate with a control unit 104.

Alternatively, rather than transmitting a test pattern, the data transmitted between the remote unit and the base station could be sampled for signal strength. Any conventional means of comparing signal strength, such as power of the signals, can be compared by the testing means.

The control unit 104 also includes means for selecting a frequency providing the strongest reception from a plurality of available channels for wireless communication between the base station and the remote unit. For example, there may be, three, or five, or even two dozen different channels, having slightly different frequencies, and the base station may send test patterns to the remote unit or sample portions of communications over more than one channel, (or possibly all of the channels) and rank the signal response.

The channel with the strongest reception (for example highest power received) or lowest amount of loss in db when comparing the test signals received versus test signals transmitted can be the channel selected for transmission. Also, conventional quality controls, such as parity checks and cyclic redundancy checks can be included in the testing, and the channel having the strongest reception can be qualified to include the strongest reception of the signals that meets all of the parity and/or redundancy checks. Otherwise, a powerful channel that is corrupting data for some reason (e.g. by interference from another user in the same bandwidth) could be selected as the channel for transmission based on signal strength alone.

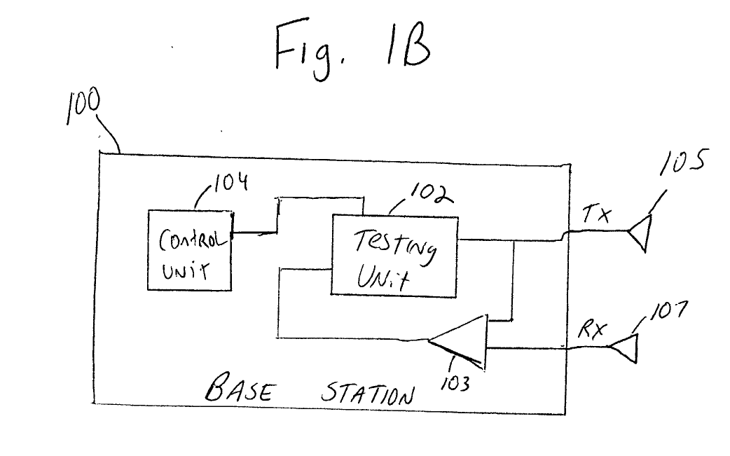

FIG. 2 illustrates that the system includes a booster station 150 so that base station and the remote unit have alternative means for communication. The booster station 150 can receive and transmit information from both the base station and the remote unit, and can be used when the signal strength between the base station and the remote unit is weak.

The booster station may communicate with the base station by wireless communication, and can also be adapted for communication by common wiring in the electrical system. U.S. Pat. No. 6,151,480 to Fischer et al. is hereby incorporated by reference as background material showing one way that electrical wiring can be used as a communication medium for RF signals.

In this aspect of the present invention, the base station and the booster unit are adapted for connection to the electrical wiring 160 in a user's home or office. Thus the base station and the booster unit can communicate through the electrical wiring and/or by wireless communication.

An advantage of using the electrical wiring is that the user may simply plug in a booster in an electrical outlet of a particular room where the computer is temporarily located to improve reception.

Additionally, the amount of RF being broadcast by both the booster station and the base station can be minimized if the control unit of the base station compares communication between the remote unit and the booster station with communication between the base station and the remote unit. If the signal strength is greater between the booster station and the remote unit, the base station can suspend wireless communication to the remote unit and use the electrical wiring to transmit data to the booster station.

However, if the communication between the base station and the remote unit is stronger than that from the booster station to the remote, the base station can suspend transmission from the booster station. In either case, the amount of RF transmissions are reduced because the base station and booster station are not always simultaneously broadcasting. This reduction in RF can be a desired feature, because there are concerns (although not proven) about the long term effects of excessive RF exposure, particularly to children.

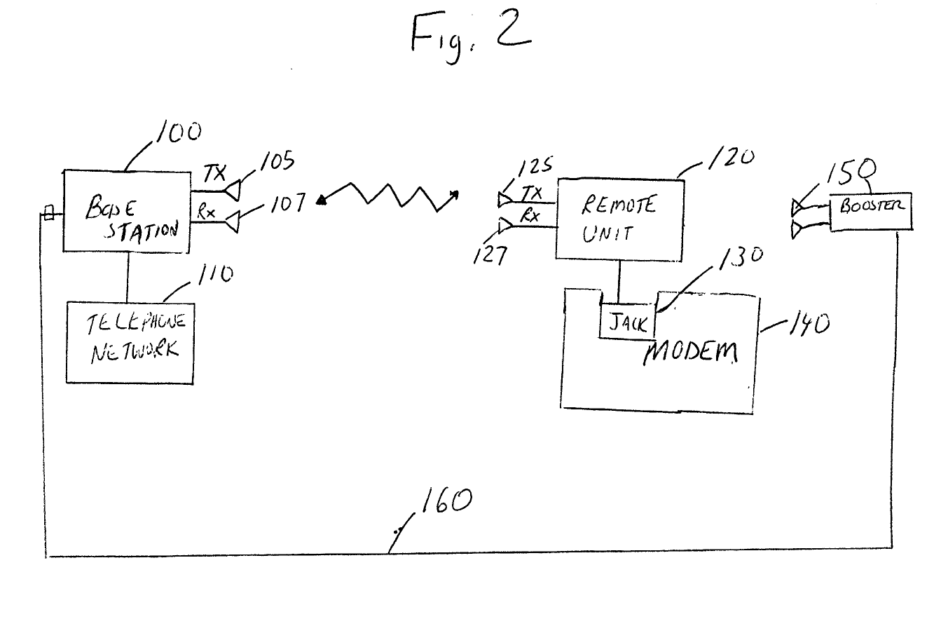

FIGS. 3-5 provide an overview of a method according to the present invention.

As shown in FIG. 3 at step 305, a base station is provided for connection with communication line. Typically, this line would be a telephone line, but the present invention is not limited by such, and this communication line could be connection to a LAN/WAN, or high speed communication line (such as DSL) are just a few examples of the types of communication lines that can be used.

At step 315, the remote unit is provided. The remote unit is adapted for connection with an interface of the modem. Typically, if the modem has a telephone-style receptacle for a modular plug, the remote unit would have a modular plug that matches the receptacle of the modem. Should the modem have a connection other than a standard telco modular plug, the remote unit may have a corresponding plug. It is also understood by persons of ordinary skill in the art that the receptacle and plug are a matter of convention, and the modem could have a plug and the remote unit the receptacle.

At step 325, wireless communication is provided between the base station and the remote unit. Typically, each of the base station and the remote unit would have at least one antenna for communication. There would be an RF generation means which would receive the data from the base station or remote unit and convert it for transmission on an RF carrier.

At step 335, the base station will test transmission between the base station and the remote unit. The remote unit can optionally conduct tests as well. This testing could be sent as a test pattern, or merely sampling some of the data before it is transmitted, and having the remote unit return the sampled data for comparison.

At step 345 the signal strength from the transmitted and received test data is compared. Optionally, other items may be used to check quality, such as parity, CRC, etc.

Steps 335 and 345 are performed for each available channel, and then step 355 selects the channel having the strongest signal strength from the tested channels.

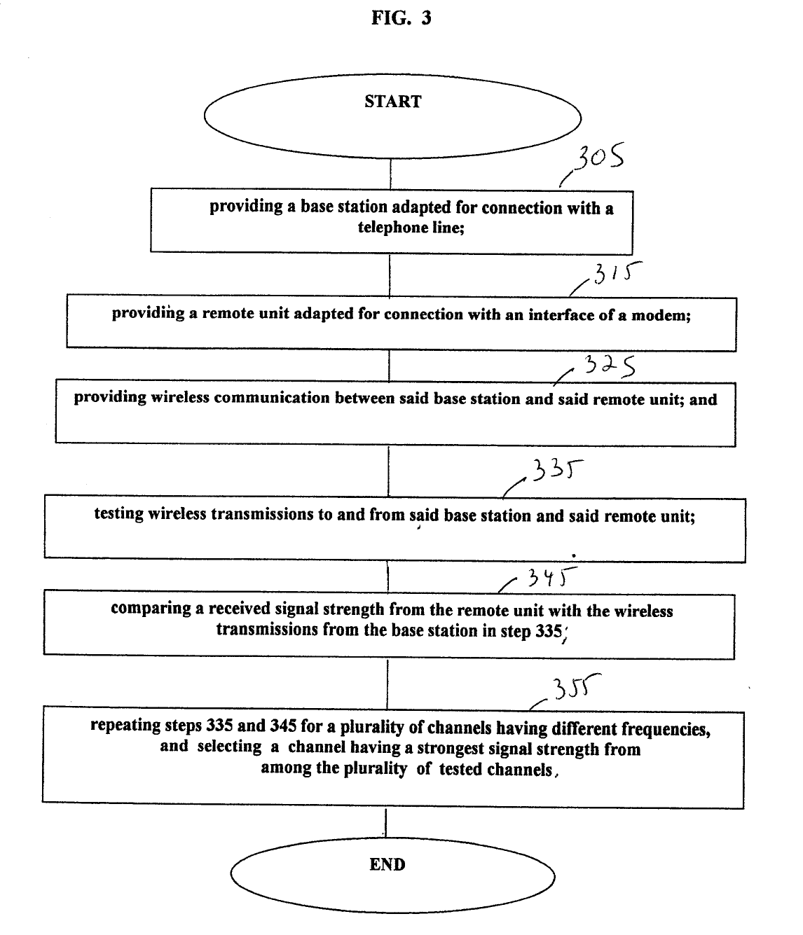

As shown in FIG. 4, the base station can be optionally provided with adaptation to an electrical outlet (step 405) and a booster station can be provided for connection to another outlet of the same electrical system (step 415).

At step 425, the base station and the booster station may communicate over the common electrical system in addition to, or in place or RF communication there between.

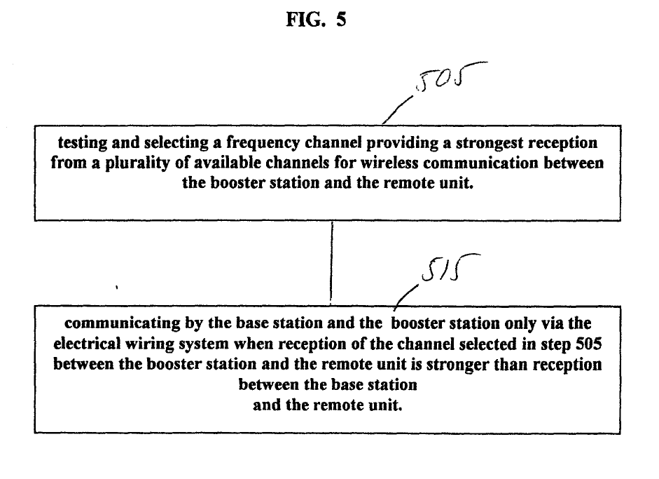

As shown in FIG. 5, the booster station may select a channel for communication with the remote unit similar to the method used for communication between the base station and the remote unit (step 505).

Finally, at step 515, the base station can compare communication between the base station and the remote unit and the booster station and the remote unit. If the reception between the base station and the remote unit is weaker than the reception between the booster station and the remote unit, the base station may optionally stop communicating with the booster station via RF and communicate using the common electrical wiring.

It should be understood by persons of ordinary skill in the art that various modifications can be made to the system and method of the present invention which are within the spirit of the invention and the scope of the appended claims.

What is claimed is:

1. A system for a cordless modem comprising:
a base station comprising means for connection with a communication line;
a remote unit for connection with an interface of a modem;
said base station including means for wireless communication with said remote unit;
said remote unit comprising means for wireless communication with at least said base station;
said base station including means for testing and selecting a frequency providing a strongest reception from a plurality of available channels for wireless communication between said base station and said remote unit.

2. The system according to claim 1, wherein said means for testing includes means for comparing levels of test patterns communicated between said base station and said remote unit.

3. The system according to claim 2 further comprising at least one booster station being in wireless communication with said base station and said remote unit, said booster station including receiving means for receiving information transmitted from said base station and said remote unit and transmitting means for transmitting information to said base station and said remote unit.

4. The system according to claim 2, wherein said base station includes means for connection with a first electrical outlet, and
said system further comprises at least one booster station being in wireless communication with said remote unit,
said booster station including means for connection with a second electrical outlet, and said base station and said at least one booster station including means for communication over a common electrical wiring system between said first and second electrical outlets.

5. The system according to claim 4, wherein said at least one booster station includes means for testing and selecting a frequency providing a strongest reception from a plurality of available channels for wireless communication between said booster station and said remote unit, and when reception between said at least one booster station and said remote unit is stronger than reception between said base station and said remote unit, said base station communicates with said at least one booster station only via the common electrical wiring system.

6. The system according to claim 5, wherein said base station periodically tests wireless communication with said remote unit and when reception between said base station and said remote unit is stronger than reception between said at least one booster station and said remote unit, said base station stops communicating with said at least one booster station via the common electrical wiring system and wirelessly communicates directly with said remote unit.

7. The system according to claim 1, wherein said remote unit is arranged in a case of a portable computer.

8. The system according to claim 3, wherein said remote unit is arranged in a case of a portable computer.

9. The system according to claim 5, wherein said remote unit is arranged in a case of a portable computer.

10. The system according to claim 7, wherein said remote unit includes an antenna arranged on the case of the portable computer so that it is oriented upward when the computer is open.

11. A method for providing a system for a cordless modem; comprising the steps of:
(a) providing a base station adapted for connection with a communication line;
(b) providing a remote unit adapted for connection with an interface of a modem;
(c) providing wireless communication between said base station and said remote unit; and
(d) testing wireless transmissions to and from said base station and said remote unit;
(e) comparing a received signal strength from the remote unit with the wireless transmissions transmitted by the base station in step (d); and
(f) repeating steps (d) and (e) for a plurality of channels having different frequencies, and selecting a channel having a strongest signal strength from among the plurality of channels.

12. The method according to claim 11, wherein step (d) comprises generating a test pattern from transmission between said base station and said remote unit.

13. The method according to claim 11, further comprising:
(g) providing at least one booster station in wireless communication with said base station and said remote unit, said booster station receiving and re-transmitting communications between said base station and said remote unit.

14. The method according to claim 12, further comprising:
(g) providing at least one booster station in wireless communication with said base station and said remote unit, said booster station receiving and re-transmitting communications between said base station and said remote unit.

15. The method according to claim 13, wherein step (a) includes providing a connection for said base station to an electrical outlet of an electrical system; and
step (g) includes providing the at least one booster station with a connection to another electrical outlet of said electrical system; and
(h) providing means for said base station and the at least one booster station to communicate over the electrical wiring system.

16. The method according to claim 14, wherein step (a) includes providing a connection for said base station to an electrical outlet of an electrical system; and
step (g) includes providing the at least one booster station with a connection to another electrical outlet of said electrical system; and
(h) providing means for said base station and the at least one booster station to communicate over the electrical wiring system.

17. The method according to claim 15, further comprising:
(i) testing and selecting a frequency channel providing a strongest reception from a plurality of available channels for wireless communication between said booster station and said remote unit.

18. The method according to claim 16, further comprising:
(i) testing and selecting a frequency channel providing a strongest reception from a plurality of available channels for wireless communication between said booster station and said remote unit.

19. The method according to claim 17 further comprising:
(j) when reception between said at least one booster station and said remote unit is stronger than reception between said base station and said remote unit, communicating by said base station with the at least one booster station only via the electrical wiring system.

20. The method according to claim 18 further comprising:
(j) when reception between said at least one booster station and said remote unit is stronger than reception between said base station and said remote unit, communicating by said base station with the at least one booster station only via the electrical wiring system.

21. The method according to claim 17 further comprising:
(j) periodically testing wireless communication with said remote unit and when reception between said base station and said remote unit is stronger than reception between the at least one booster station and said remote unit, said base station stops communicating with the at least one booster station via the common electrical wiring system and communicates directly with said remote unit by wireless communication.

22. The method according to claim 21, further comprising:
(k) periodically testing wireless communication with said remote unit and when reception between said base station and said remote unit is stronger than reception between the at least one booster station and said remote unit, said base station stops communicating with the at least one booster station via the common electrical wiring system and communicates directly with said remote unit by wireless communication.
